(19) United States
(12) Patent Application Publication
(10) Pub. No.: US 2007/0208617 A1
(43) Pub. Date: Sep. 6, 2007

(54) Product carriage car that has fields for advertisements

(76) Inventor: Sabri Sami Toker, Sirameseler-Bursa (TR)

Correspondence Address: ABELMAN, FRAYNE & SCHWAB, 666 THIRD AVENUE, 10TH FLOOR, NEW YORK, NY, 10017, US

(21) Appl. No.: 11/369,323

(22) Filed: Mar. 6, 2006

(51) Int. Cl. G06Q 30/00

(52) U.S. Cl. 705/14

(57) ABSTRACT

A product carriage car includes exposed areas for advertisements for use as a bag and package container to carry desired products for any kind of commercial organizations, marketing, sales, promotions, and while being used as a bag or package container, the product carriage care presents the exposed advertisement for products to other consumers. The product carriage car has carriage members, extension members which fit into the carriage members, a base joined at a bottom point of the carriage members, wheels rotating about an axle, feet which ensure that the product carriage car stays level while not in motion, a handle at the top joint of the extension members, and a document carriage container.

### BACKGROUND OF THE INVENTION

1. Field of the Invention

This invention is about a product carriage car that has areas thereon for advertisements and is designed to be used as a bag and package container to carry desired products for any kind of commercial organizations, marketing, sales, promotions, and while being used as a bag or package container, the product carriage car presents the product advertisements located thereon to other consumers.

2. Description of the Related Art

Nowadays companies are taking part at fairs, trade shows, and other events to directly present the goods that are state of the art and that such companies have developed for customers. Fairs are usually a gathering place for companies from the same field of activity and which publicize the sectors that the consumers are interested in detail while aiming to show the goods of the companies that take part at the fair together to the consumers. During fairs, companies also present catalogues, brochures, price lists and various other informative materials to the consumers to inform them in detail about their products. Taking into consideration that there are many companies at fair grounds and that each company has more than one product, it can be understood that taking all the catalogues and carrying them is difficult. After informative materials that one is able to carry are collected, other informative material from other companies cannot be taken, which prevents consumers from comparing different companies and prevents them from being completely informed.

One of the most important issues about advertisements is giving them at the right time and to the right target group. Since the majority of the consumers located at a fair have come to the fair to be informed about the sector that they are interested in or that they have come to buy from, advertisements given to consumers at locations in a fair will meet the advertising goals of the company.

### BRIEF SUMMARY OF THE INVENTION

To give an example, the use of the disclosed invention in fairs has been described in detail and the goal of this invention is the same in other sectors.

This invention is about an advertisement-bearing car or apparatus that may be given free of charge to consumers at the entrances of fairs, which prevents all the disadvantages explained above, and which ensures that consumers will be able to carry the informative documents that they have collected from the fair grounds with ease and at the same time that they carry and display the advertisements that are located on the car to be displayed to and viewed by other consumers.

This carriage car can be used at all types of commercial organizations and events in addition to fairs, with fairs being described herein as an example of use in the fields given below. The usage of the invention is the same at all the sectors which can be described as this: the invention is given to the consumer free of charge which ensures that products and materials of consumers are carried in it and advertisements on it are conveyed to other consumers.

The sectors in which the invention may be used include:
at malls;
in the tourism sector, hotels, agencies, land, air transportation companies;
at meetings and symposiums of health, medicine and medical sectors;
as a package for products that are not easy to carry;
as a package for samples, bed sheets and cover sets of the textile sector; and
as a tool for similar promotional and packaging material.

### BRIEF DESCRIPTION OF THE SEVERAL VIEWS OF THE DRAWINGS

Preferred embodiments of the invention are disclosed hereinbelow with reference to the drawings, wherein:

FIG. 1 is a three dimensional top front left perspective view of the advertisement car of the present invention; and

FIG. 2 is a three dimensional top front right perspective view of the advertisement car of FIG. 1.

### DETAILED DESCRIPTION OF THE INVENTION

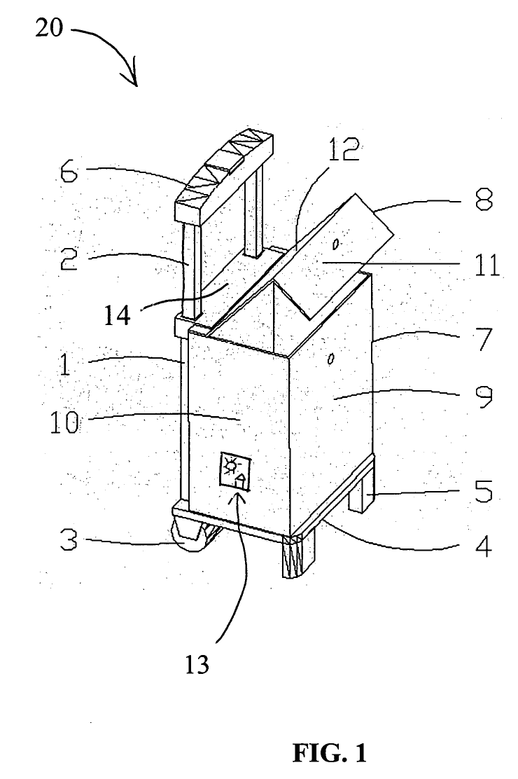

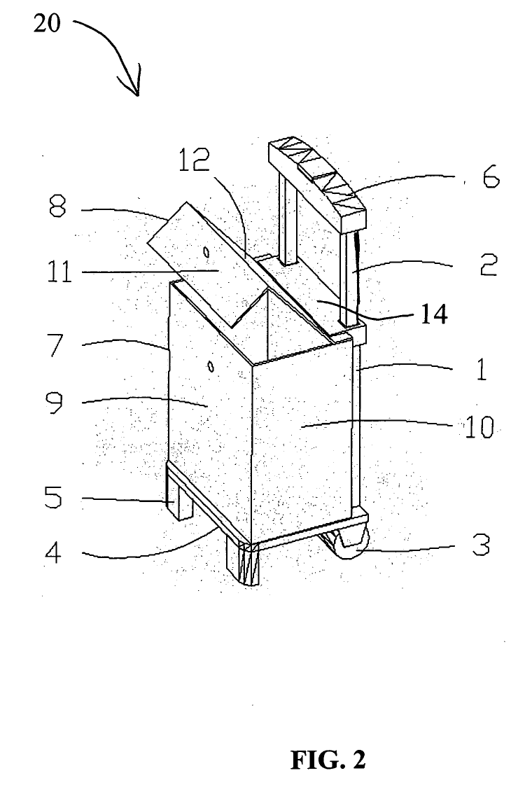

The present invention shown in FIGS. 1-2 is described with the following reference numerals:
1 carriage members;
2 extension members;
3 wheels;
4 base;
5 feet
6 handle;
7 document carriage container;
8 cover;
9 front advertisement area;
10 side advertisement area;
11 cover advertisement area;
12 top advertisement area;
13 advertisement;
14 fastening plate; and
20 product carriage car.

As shown in FIGS. 1-2, the product carriage car 20 may be embodied as a cart or other devices, such as a luggage cart or wheeled travel bag attached or attachable to a truck or dolly, that has fields or regions thereon externally exposed for displaying advertisements. The product carriage car 20 of the present invention has wheels 3 and feet 5 mounted under the base 4 which has a carriage member 1 attached. In an example embodiment shown in FIGS. 1-2, two carriage members 1 are attached to the base 4 using known fastening devices, such as screws or nuts and bolts. The wheels 3 ensure an easy movement of the car 20 by rotating about respective axles in the same direction of the direction of movement of the carriage car 20. The feet 5 ensure that the car 20 stays level while the car 20 is motionless. That is, the feet 5 have a predetermined height, such as being substantially identical in height as the wheels 3 relative to the ground, so that when the car 20 is motionless, the car 20 does not significantly tilt and fall over.

At least one extension member 2 is provided. In an example embodiment shown in FIGS. 1-2, two extension members 2 are provided which are shaped so that the extension members 2 fit in the carriage members 1 and can be adjusted according to the height of the person carrying or pulling the carriage car 20 using known adjustment devices. The handle 6 at the top of the extension members 2 is the dragging point for the person that is moving the car 20.

The document carriage container 7 may be a bag, a box, or any other known storage device, and is capable of retaining and carrying documents, such as papers and transparencies, as well as objects such as souvenirs, trinkets, personal electronics such as an “IPOD” commercially available from “APPLE COMPUTER”, pens, calculators, and other objects and accessories obtained or brought to a fair or trade show. Accordingly, the document carriage container 7 is not limited to retaining and carrying paper documents.

The document carriage container 7 is placed and retained on the carriage members 1 over the base 4, for example, using fastening or securing devices known in the art, such as a fastening plate 14. The fastening plate 14 may be adjusted vertically up or down the carriage members 1 and removably secured to any vertical position using any known adjustment devices to accommodate any sized container 7. The dimensions of the container 7 can be changed and/or the container 7 may be replaced with a different sized container according to the demand or need of the consumer. Again according to the demand or need of the consumer, a cover 8 can optionally be placed on the container 7 to cover the documents therein.

According to the specifications given herein, the product carriage car 20 enables its users to carry and protect the documents obtained in a fair, trade show, or other events which are placed in the container 7. During this carrying action, the container 7 is made visible and/or noticeable to the other consumers at the fair via the advertisements located on areas on the walls forming the sides of the container 7, with the advertisements being in different colors, designs, dimensions, shapes, and characters that are located on areas of the container 7.

The document carriage container 7 has at least one wall which may be rigid and/or substantially rigid, for example, by being composed of substantially rigid material. The at least one wall of the document carriage container 7 forms and/or provides a front advertisement area 9, a side advertisement area 10, a cover advertisement area 11, and a top advertisement area 12 which constitute the outside of the carriage container 7, such that each of these advertisement areas hold at least one advertisement 13. Such advertisement areas may be sub-regions of the walls forming the document carriage container 7, such that such sub-regions for displaying advertisements are designed to have substantially the same dimensions; for example, to retain advertisements of a predetermined and/or standardized size and set of dimensions.

The document carriage container 7 can be produced from hard and solid materials, such as plastic, cardboard, light metal, etc., and can also be produced from textile fabrics in the shape of paper and plastic bags, and other materials including synthetic materials such as nylon, or a combination of hard and solid materials, textile fabrics, and synthetic materials. The advertisements are secured to the advertisement areas using known fastening devices or materials, such as clasps or adhesives. In such cases should be placed on the textile fabric or the nylon.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A product carriage car with an advertisement area thereupon, the product carriage car comprising:
a carriage member;
an extension member which fits into the carriage member and is capable of extending therefrom;
a base joined to a bottom point of the carriage member;
a wheel mounted to the base and rotatable about an axle;
a foot member which ensures that the product carriage car stays level while not in motion;
a handle at a top location of the extension member; and
a document carriage container on the base and having a wall with the advertising area thereupon and exposed for display of an advertisement.

2. The product carriage car of claim 1, wherein the wall of the document carriage container includes:
a front advertisement area;
a side advertisement area;
a cover advertisement area; and
a top advertisement area;
wherein such front, side, cover, and top advertising areas constitute the outside of the document carriage container.

3. The product carriage car of claim 1, wherein at least one of the front, side, cover, and top advertising areas has the advertisement attached thereto for display, wherein the advertisement is selected from the group consisting of: colors, designs, dimensions, shapes, and characters.

4. The product carriage car of claim 1, wherein the wall of the document carriage container is composed of material selected from the group consisting of: hard and solid material, textile fabric material, and synthetic material.

5. The product carriage car of claim 4, wherein the hard and solid material is selected from the group consisting of: plastic, cardboard, and light metal.

6. The product carriage car of claim 4, wherein the textile fabric material includes textile fabrics in the shape of a bag.

7. The product carriage car of claim 4, wherein the synthetic material includes nylon.

8. The product carriage car of claim 1, wherein the wall is rigid.

9. The product carriage car of claim 1, wherein the wall is substantially rigid.

10. The product carriage car of claim 1, wherein the wall is composed of a substantially rigid material.

11. A product carriage car with an advertisement area thereupon, the product carriage car comprising:
carriage members;
extension members which fit into the carriage members and are capable of extending therefrom;
a base joined to respective bottom points of the carriage members;
wheels mounted to the base and rotatable about respective axles;
feet which ensure that the product carriage car stays level while not in motion;
a handle at respective top locations of the extension members;
a document carriage container on the base and having a wall with the advertising area thereupon and exposed for display of an advertisement; and
a fastening plate for retaining the document carriage container on the base.

12. The product carriage car of claim 11, wherein the wall of the document carriage container includes:
a front advertisement area;
a side advertisement area;
a cover advertisement area; and
a top advertisement area;
wherein such front, side, cover, and top advertising areas constitute the outside of the document carriage container.

13. The product carriage car of claim 11, wherein at least one of the front, side, cover, and top advertising areas has the advertisement attached thereto for display, wherein the advertisement is selected from the group consisting of: colors, designs, dimensions, shapes, and characters.

14. The product carriage car of claim 11, wherein the wall of the document carriage container is composed of materials selected from the group consisting of: hard and solid materials, textile fabric materials, and synthetic materials.

15. The product carriage car of claim 14, wherein the hard and solid materials are selected from the group consisting of: plastic, cardboard, and light metal.

16. The product carriage car of claim 14, wherein the textile fabric materials include textile fabrics in the shape of a bag.

17. A product carriage car that has advertisement areas on it, comprising:
carriage profiles (1);
extension profiles (2) that are shaped so that they fit in the carriage profiles (1);
a base (4) joined at the bottom point of the carriage profiles (1),
revolving wheels (3),
feet (5) that ensure the car stays level while it is motionless,
a handle (6) at the top joint of the extension profiles (2), and
a document carriage bag (7).

18. The product carriage car of claim 17, further comprising:
a front advertisement area (9);
a side advertisement area (10);
a cover advertisement area (11); and
a top advertisement area (12) which constitute the outside of it.

19. The product carriage car of claim 17, wherein advertisements in different colors, designs, dimensions, shapes and characters can be attached to the outer parts of it (9, 10, 11, 12).

20. The product carriage car of claim 17, wherein the document carriage bag (7) can be produced from hard and solid materials, including plastic, cardboard, and light metal, and can also be produced from textile fabrics in the shape of paper and plastic bags, and materials such as nylon.
